(19) United States
(12) Patent Application Publication
(10) Pub. No.: US 2018/0316014 A1
(43) Pub. Date: Nov. 1, 2018

(54) BINDER COMPOSITION FOR ELECTRODES OF LITHIUM ION BATTERIES

(71) Applicants: Ranjan DASH, Royersford, PA (US); SABIC Global Technologies B.V., Bergen op Zoom (NL)

(72) Inventors: Ranjan Dash, Royersford, PA (US); Prince Xavier, Thuwal (SA); Jessica Scaranto, Thuwal (SA)

(21) Appl. No.: 15/771,471

(22) PCT Filed: Aug. 30, 2016
(86) PCT No.: PCT/US2016/049481

§ 371 Date: Apr. 27, 2018

Related U.S. Application Data
(60) Provisional application No. 62/247,594, filed on Oct. 28, 2015.

(51) Int. Cl. H01M 4/62; H01M 4/58; H01M 4/525; H01M 4/134; H01M 4/136; H01M 4/04; H01M 10/0525

(52) U.S. Cl. CPC H01M 4/623; H01M 4/5815; H01M 4/5825; H01M 4/525; H01M 10/0525; H01M 4/136; H01M 4/0402; H01M 4/624; H01M 4/134

(57) ABSTRACT

An electrode material comprising (a) a polymeric binder, (b) a lithium-based electrochemically active material, and (c) an electrically conductive filler; wherein the polymeric binder comprises one or more sulfur-based functional groups; and wherein the electrode material is characterized by a binding energy between the one or more sulfur-based functional groups and the lithium-based electrochemically active material of from about 0.3 eV to about 2.5 eV. A method of making a battery electrode comprising (i) mixing a lithium-based electrochemically active material, an electrically conductive filler, and a polymeric binder to form an electrode material, wherein the polymeric binder comprises one or more sulfur-based functional groups, and (ii) contacting the electrode material with a current collector to form the battery electrode.

### TECHNICAL FIELD

The present disclosure relates to lithium ion batteries (LIBs), more specifically binder compositions for LIBs and methods of making and using same.

### BACKGROUND

For the past two decades, significant efforts have been dedicated towards the development of lithium ion batteries (LIBs), specifically high energy density LIBs. The energy density of a LIB primarily depends on the specific capacity of its cathode and anode, and the voltage window at which the battery can be cycled. Silicon (Si) has emerged as one of the promising anode materials for high energy density LIBs. Si offers a suitable low voltage for anodes and a high theoretical specific capacity of −4,200 mAh/g based on the formation of a Li₂₂Si₅ alloy, which specific capacity is about 10 times higher than that of conventional carbon based anodes (−372 mAh/g). However, Si expands volumetrically by up to 400% upon full lithium insertion to form the Li₂₂Si₅ alloy, and it shrinks upon lithium extraction.

Existing (e.g., conventional) binders such as polyvinylidene fluoride (PVDF), styrene butadiene rubber (SBR), and others, cannot be used in Si-based electrodes, as they do not bind well with silicon or lithium silicates and do not have the ability to expand and/or contract to allow for volume changes without loss in contact (e.g., electrical conductivity contact) between electrode material particles (e.g., electrochemically active material particles, electrically conductive filer particles, etc.) and a current collector. Conventional binders (e.g., PVDF, SBR) used in LIBs attach to silicon and/or lithium silicates via weak van der Waals forces, and thus fail to accommodate large changes in spacing between electrode material particles during charging, and discharging. During repeated charging/discharging, conventional binders become inefficient in holding the electrode material particles together and maintaining good electrical conductivity within the electrode, thereby resulting in capacity fading and increase in resistance.

Generally, relatively large amounts of conventional binder material are required for manufacturing of electrodes (e.g., anodes and cathodes), owing to a lack of binding strength of conventional binders (e.g., PVDF, SBR). Typically, 5-15 wt. % of conventional binder is used for manufacturing of electrodes. As binders do not contribute directly to the energy density of LIBs, decreasing the binder amount would allow the use of a higher amount of electrochemically active material, thus leading to an increase in the energy density of LIB. Excessive binder content in the electrode can also lead to a decrease in ionic conductivity of the electrode due to ion-blocking property of the ionic insulating binder. Further, a decrease in binder content could lead to a decrease in LIBs' raw material and processing cost. Thus, there is an ongoing need for the development of binder material compositions for LIBs.

### BRIEF SUMMARY

Disclosed herein is an electrode material comprising (a) a polymeric binder, (b) a lithium-based electrochemically active material, and (c) an electrically conductive filler; wherein the polymeric binder comprises one or more sulfur-based functional groups; and wherein the electrode material is characterized by a binding energy between the one or more sulfur-based functional groups and the lithium-based electrochemically active material of from about 0.3 eV to about 2.5 eV.

Also disclosed herein is a method of making a battery electrode comprising (i) mixing a lithium-based electrochemically active material, an electrically conductive filler, and a polymeric binder to form an electrode material, wherein the polymeric binder comprises one or more sulfur-based functional groups, and (ii) contacting the electrode material with a current collector to form the battery electrode.

### BRIEF DESCRIPTION OF THE DRAWINGS

For a detailed description of the preferred embodiments of the disclosed methods, reference will now be made to the accompanying drawings in which:

FIG. 1A displays a schematic of a silicon anode comprising a conventional binder during charging and discharging of a lithium ion battery (LIB);

FIG. 1B displays a schematic of a silicon anode comprising a polymeric binder comprising one or more sulfur-based functional groups during charging and discharging of a LIB; and

FIG. 2 displays a graph of binding interactions (expressed as binding energies) of different sulfur-based functional groups with various silicon lithiates anodes (A) and different cathode active materials (B).

### DETAILED DESCRIPTION

Disclosed herein are polymeric binders and methods of making and using same. Also disclosed herein are electrode materials comprising polymeric binders and methods of making and using same. In an embodiment, an electrode material can comprise (a) a polymeric binder, (b) a lithium-based electrochemically active material, and (c) an electrically conductive filler; wherein the polymeric binder comprises one or more sulfur-based functional groups; and wherein the electrode material is characterized by a binding energy between the one or more sulfur-based functional groups and the lithium-based electrochemically active material of from about 0.3 eV to about 2.5 eV.

In an embodiment, a battery electrode can comprise an electrode material comprising a polymeric binder. In some embodiments, the battery electrode can be configured as an anode. In other embodiments, the battery electrode can be configured as a cathode.

In an embodiment, a method of making a battery electrode can comprise (i) mixing a lithium-based electrochemically active material, an electrically conductive filler, and a polymeric binder to form an electrode material, wherein the polymeric binder comprises one or more sulfur-based functional groups; and (ii) contacting the electrode material with a current collector to form the battery electrode.

Other than in the operating examples or where otherwise indicated, all numbers or expressions referring to quantities of ingredients, reaction conditions, and the like, used in the specification and claims are to be understood as modified in all instances by the term “about.” Various numerical ranges are disclosed herein. Because these ranges are continuous, they include every value between the minimum and maximum values. The endpoints of all ranges reciting the same characteristic or component are independently combinable and inclusive of the recited endpoint. Unless expressly indicated otherwise, the various numerical ranges specified in this application are approximations. The endpoints of all ranges directed to the same component or property are inclusive of the endpoint and independently combinable. The term “from more than 0 to an amount” means that the named component is present in some amount more than 0, and up to and including the higher named amount.

The terms “a,” “an,” and “the” do not denote a limitation of quantity, but rather denote the presence of at least one of the referenced item. As used herein the singular forms “a,” “an,” and “the” include plural referents.

As used herein, “combinations thereof” is inclusive of one or more of the recited elements, optionally together with a like element not recited, e.g., inclusive of a combination of one or more of the named components, optionally with one or more other components not specifically named that have essentially the same function. As used herein, the term “combination” is inclusive of blends, mixtures, alloys, reaction products, and the like.

Reference throughout the specification to “an embodiment,” “another embodiment,” “other embodiments,” “some embodiments,” and so forth, means that a particular element (e.g., feature, structure, property, and/or characteristic) described in connection with the embodiment is included in at least an embodiment described herein, and may or may not be present in other embodiments. In addition, it is to be understood that the described element(s) can be combined in any suitable manner in the various embodiments.

As used herein, the terms “inhibiting” or “reducing” or “preventing” or “avoiding” or any variation of these terms, include any measurable decrease or complete inhibition to achieve a desired result.

As used herein, the term “effective,” means adequate to accomplish a desired, expected, or intended result.

As used herein, the terms “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”) are inclusive or open-ended and do not exclude additional, unrecited elements or method steps.

Unless defined otherwise, technical and scientific terms used herein have the same meaning as is commonly understood by one of skill in the art.

Compounds are described herein using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through the carbon of the carbonyl group.

In an embodiment, a battery electrode can comprise (i) a current collector and (ii) an electrode material; wherein the electrode material can comprise (a) a polymeric binder, (b) a lithium-based electrochemically active material, and (c) an electrically conductive filler; wherein the polymeric binder comprises one or more sulfur-based functional groups.

In an embodiment, the electrode material can be characterized by a binding energy between the one or more sulfur-based functional groups of the polymeric binder and the lithium-based electrochemically active material of from about 0.3 eV to about 2.5 eV, alternatively from about 0.4 eV to about 2.0 eV, or alternatively from about 0.5 eV to about 1.6 eV. Generally, the binding energy refers to the energy required to decompose a system into its constituent parts. For purposes of the disclosure herein, the “binding energy” refers to the energy required to separate the sulfur-based functional groups from the lithium-based electrochemically active material. A methodology for calculating binding energy is provided in the Examples. Without wishing to be limited by theory, the upper-bound value of the binding energy could go up to about 2.5 eV, by considering the accuracy of density functional theory (DFT) calculations (as outlined in the Examples) and by considering a synergistic effect (e.g., enhancing binding energy values) while using combinations of sulfur-based functional groups (e.g., using more than one sulfur-based functional groups) on a polymer backbone.

Non-limiting examples of current collectors suitable for use in the present disclosure include any suitable electrical conductor, metals, copper (Cu), aluminum (Al), nickel (Ni), iron (Fe), steel, stainless steel, graphite, graphene, carbon nanotubes, metallic nanowires, and the like, or combinations thereof. In an embodiment, the battery electrode comprises an anode, and the current collector comprises Cu. In another embodiment, the battery electrode comprises a cathode, and the current collector comprises Al.

In an embodiment, the electrode material can comprise a polymeric binder, wherein the polymeric binder comprises one or more sulfur-based functional groups. Generally, a binder (e.g., a polymeric binder) can be used in an electrode material to hold electrochemically active material particles together and in contact with the current collectors.

In an embodiment, each of the one or more of the sulfur-based functional groups can be independently selected from a sulfonyl group, a sulfo group, a thiol group, a S-nitrosothiol group, a sulfide group, a disulfide group, a sulfenic acid group, a sulfinic acid group, a sulfonate ester group, a sulfoxide group, a thiocyanate group, an isothiocyanate group, and the like, or combinations thereof.

In an embodiment, the sulfonyl group can comprises sulfonyl halide, sulfonyl chloride, sulfonyl bromide, sulfonyl fluoride, p-toluenesulfonyl, p-bromobenzenesulfonyl, 2-nitrobenzenesulfonyl, 4-nitrobenzenesulfonyl, methanesulfonyl, trifluoromethanesulfonyl, 5-(dimethylamino)naphthalene-1-sulfonyl, and the like, or combinations thereof.

In an embodiment, the sulfide group can comprise an alkyl sulfide, a methyl sulfide, ethyl sulfide, propyl sulfide, butyl sulfide, an aryl sulfide, an arylalkyl sulfide, and the like, or combinations thereof.

In an embodiment, the sulfonate ester can comprise an alkyl sulfonate ester, a methyl sulfonate ester, an ethyl sulfonate ester, a propyl sulfonate ester, a butyl sulfonate ester, an aryl sulfonate ester, an arylalkyl sulfonate ester, and the like, or combinations thereof.

In an embodiment, the sulfoxide group can comprise an alkyl sulfoxide, methyl sulfoxide, ethyl sulfoxide, propyl sulfoxide, butyl sulfoxide, an aryl sulfoxide, an arylalkyl sulfoxide, and the like, or combinations thereof.

In an embodiment, the sulfo group can comprise an alkyl sulfo group, a methyl sulfo group, an ethyl sulfo group, a propyl sulfo group, a butyl sulfo group, an aryl sulfo group, an arylalkyl sulfo group, and the like, or combinations thereof.

In an embodiment, the sulfenic acid group can comprise an alkyl sulfenic acid group, a methyl sulfenic acid group, an ethyl sulfenic acid group, a propyl sulfenic acid group, a butyl sulfenic acid group, an aryl sulfenic acid group, an arylalkyl sulfenic acid group, and the like, or combinations thereof.

In an embodiment, the sulfinic acid group can comprise an alkyl sulfinic acid group, a methyl sulfinic acid group, an ethyl sulfinic acid group, a propyl sulfinic acid group, a butyl sulfinic acid group, an aryl sulfinic acid group, an arylalkyl sulfinic acid group, and the like, or combinations thereof.

In an embodiment, the polymeric binder can comprise a polymer backbone selected from the group consisting of polyvinyl, polyvinyl ester, polyvinyl ether, polyvinyl ketone, polyvinyl halide, polyester, polyolefin, polyethylene, polypropylene, polyarylene sulfide, polyphenylene sulfide, polysulfone, polyethersulfone, polythioester, polythioether, polyphenylene oxide, polystyrene, styrene-butadiene rubber, polyacrylate, polyacrylonitrile, polymethacrylate, polyetherimide, polyamide, polyacrylamide, phenolic polymer, fluoropolymer, furan polymer, polycarbamate, polyurethane, polycarbonate; conductive polymers; polyacetylene, polydiacetylene, polypyrrole, polythiophene; polyphenylene, poly(paraphenylene), poly(p-phenylene vinylene), poly(phenyleneethynylene), polyaniline; polyene, polaron, bipolaron, soliton; polyfluorene; analogues thereof; copolymers thereof; and combinations thereof. As will be appreciated by one of skill in the art, and with the help of this disclosure, the polymer backbone of the polymeric binder can be any polymer backbone compatible with the electrode materials and otherwise compatible with the battery environment.

In an embodiment, the polymeric binder can comprise a conductive polymer. Non-limiting examples of conductive polymers suitable for use in the present disclosure include polyacetylene, polydiacetylene, polypyrrole, polythiophene; polyphenylene, poly(paraphenylene), poly(p-phenylene vinylene), poly(phenyleneethynylene), polyaniline; polyene, polaron, bipolaron, soliton; polyfluorene; analogues thereof; copolymers thereof; or combinations thereof.

In an embodiment, the polymer backbone of the polymeric binder excludes a polyimide.

In some embodiments, the polymeric binder can be obtained by polymerizing at least one monomer comprising one or more sulfur-based functional group into the polymer backbone.

In other embodiments, the polymeric binder can be obtained by chemically functionalizing the polymer backbone with one or more sulfur-based functional groups. The polymeric backbone can be functionalized by using any suitable methodology. As will be appreciated by one of skill in the art, and with the help of this disclosure, any suitable polymeric backbone that is known to be operable in a battery electrode environment can be chemically functionalized with one or more sulfur-based functional groups to obtain a polymeric binder of the type disclosed herein.

Various embodiments of polymeric binders are possible, wherein the polymer binder may comprise one or more types of binders, and each type of binder may comprise a polymer backbone and one or more sulfur-based functional groups. As noted previously, each of the one or more of the sulfur-based functional groups can be independently selected from the groups described herein. Likewise, the polymer backbone described herein may be independently selected. In some embodiments, all of the one or more sulfur-based functional groups and all of the polymeric backbones are the same. In other embodiments, the one or more sulfur-based functional groups and/or one or more of the polymeric backbones are different. Accordingly, various embodiments of polymeric binders are possible, wherein one or more types of polymer binder may comprise various combinations of polymer backbone and sulfur-based functional groups, including: (i) a plurality of common (i.e., single) type of polymeric backbones having a plurality of a common (i.e., single) type of sulfur-based functional groups; (ii) a plurality of common (i.e., single) type of polymeric backbones having a plurality of a different types of sulfur-based functional groups; (iii) a plurality of different types of polymeric backbones, wherein each different type of polymeric backbone has a plurality of a common (i.e., single) type of sulfur-based functional groups; (iv) a plurality of different types of polymeric backbones, wherein each different type of polymeric backbone has a plurality of a different types of sulfur-based functional groups; and combinations thereof.

As will be appreciated by one of skill in the art, and with the help of this disclosure, a polymeric binder can be selected based on the electrode material and/or the electrode material environment. For example, some electrode materials, such as silicon-based electrode materials, can exhibit large volumetric changes during charging and discharging cycles (sometimes up to 400% volume changes), and as such, one of skill in the art, and with the help of this disclosure, could select a polymeric material (or a polymeric backbone to functionalize with one or more sulfur-based functional groups) suitable as a polymeric binder based on the type of electrochemically active materials present in the electrode, and based on the expansion/contraction characteristics of the electrode materials in view of charge/discharge cycles.

In an embodiment, the polymeric binder can be present in the electrode material in an amount that is reduced by equal to or greater than about 25 wt. %, alternatively equal to or greater than about 30 wt. %, or alternatively equal to or greater than about 40 wt. %, based on the total weight of the electrode material, when compared to an otherwise similar electrode material comprising a polymeric binder lacking one or more sulfur-based functional groups.

In an embodiment, the battery electrode can be configured as an anode, wherein the lithium-based electrochemically active material comprises a lithium-silicon compound characterized by formula LiₓSi_{y}; wherein x is an integer from 1 to about 25, alternatively from 2 to about 22, or alternatively from 3 to about 15; wherein y is an integer from 1 to about 10, alternatively from 1 to about 7, or alternatively from 1 to about 5; and wherein x is equal to or greater than y. The anode is the negative electrode of a primary or non-rechargeable cell and is always associated with the oxidation or the release of electrons into an external circuit. In a secondary or rechargeable cell, the anode is the negative pole during discharging the battery and the positive pole during charging the battery. During battery charging, lithium is inserted into the anode, wherein it may cause a volumetric increase of a silicon material of up to about 400%. During battery discharging, lithium is extracted from the anode, and the silicon material can experience a volumetric decrease of up to about 400%. As will be appreciated by one of skill in the art, and with the help of this disclosure, when the electrode (e.g., anode) experiences a great volumetric expansion, in conventional electrodes, electrode material particles can lose electrical contact with each other, leading to an increase in electrode resistance and a decrease in electrode capacity. Without wishing to be limited by theory, the polymeric binder disclosed herein can bind strongly to electrode materials (e.g., electrochemically active materials, electrically conductive materials, etc.) and can hold them closer together, such that they remain in electrical contact with each other, thereby reducing or eliminating an increase in electrode resistance and a decrease in electrode capacity that would be due to material swelling.

Non-limiting examples of lithium-silicon compounds suitable for use in the present disclosure include Li₁₅Si₄, Li₂₂Si₅, Li₁₂Si₇, Li₂Si₁, Li₁Si₁, Li₁₃Si₄, Li₇Si₃, Li₇Si₂, and the like, or combinations thereof.

In an embodiment, the anode can be characterized by a drop in specific capacity over a battery cycle life that is decreased by equal to or greater than about 30%, alternatively equal to or greater than about 40%, or alternatively equal to or greater than about 50%, when compared to an otherwise similar anode comprising a polymeric binder lacking one or more sulfur-based functional groups. Generally, the specific capacity of an electrode refers to the amount of charge per unit weight, volume, or area that a battery electrode material contains, often expressed as mAh/g, mAh/cm³, or mAh/cm². The specific capacity of an electrode is a fundamental characteristic of the electrode material, and depends upon its redox chemistry and structure.

In an embodiment, the anode can be characterized by a drop in specific capacity over a battery cycle life of less than about 30%, alternatively less than about 20%, or alternatively less than about 10%. Generally, a conventional lithium based anode can be characterized by a drop in specific capacity over a battery cycle life of equal to or greater than about 30%, alternatively equal to or greater than about 40%, or alternatively equal to or greater than about 50%.

In an embodiment, the battery electrode can be configured as a cathode, wherein the lithium-based electrochemically active material comprises a lithium-transition metal oxide, FeF₃, FeF₂, CoF₂, NiF₂, FeS₂, V₂O₅, and the like, or combinations thereof. The cathode is the positive electrode of a primary or non-rechargeable cell and is always associated with the reduction or the intake of electrons from the external circuit. In a secondary or rechargeable cell, the cathode is the positive pole during discharging the battery and the negative pole during charging the battery.

Non-limiting examples of lithium-transition metal oxides suitable for use in the present disclosure include lithium cobalt oxide (LiCoO₂, LCO), lithium manganese oxide (LiMn₂O₄, LMO), lithium nickel manganese cobalt oxide (LiNiMnCoO₂, NMC), lithium nickel cobalt aluminum oxide (LiNiCoAlO₂), lithium titanate (Li₄Ti₅O₁₂), lithium iron borate (LiFeBO₃), lithium vanadium fluorophosphate (LiVPO₄F), lithium manganese phosphate (LiMnPO₄), lithium manganese silicate (Li₂MnSiO₄), and the like, or combinations thereof.

In an embodiment, the cathode can be characterized by an energy density that is increased by equal to or greater than about 5%, alternatively equal to or greater than about 10%, or alternatively equal to or greater than about 15%, when compared to an otherwise similar cathode comprising a polymeric binder lacking one or more sulfur-based functional groups. Generally, the energy density of a material (e.g., electrode material) refers to the energy per unit volume or weight of a material, often expressed as Wh/L or Wh/kg. Energy density of an electrode is a product of the voltage and capacity per unit volume or weight.

In an embodiment, the lithium-based electrochemically active material can be present in the electrode material in an amount that is increased by equal to or greater than about 25 wt. %, alternatively equal to or greater than about 30 wt. %, or alternatively equal to or greater than about 40 wt. %, based on the total weight of the electrode material, when compared to an otherwise similar electrode material comprising a polymeric binder lacking one or more sulfur-based functional groups. Without wishing to be limited by theory, the binding energy values between the sulfur-based functional groups and the lithium-based electrochemically active material allow for the use of a reduced amount of polymeric binder as disclosed herein, which in turn allows for the use of an increased amount of the lithium-based electrochemically active material.

In an embodiment, the electrode material can comprise an electrically conductive filler. Generally, electrodes can employ an electrically conductive filler to maintain electrical conductivity between electrode material particles and reduce ohmic loses within the electrodes.

Non-limiting examples of electrically conductive filler suitable for use in the present disclosure include carbon, carbon black, carbon fiber, carbon nanotubes, graphite, metal fibers, copper, copper nanoparticles, and the like, or combinations thereof.

In an embodiment, a method of making a battery electrode can comprise (i) mixing a lithium-based electrochemically active material, an electrically conductive filler, and a polymeric binder to form an electrode material, wherein the polymeric binder comprises one or more sulfur-based functional groups; and (ii) contacting the electrode material with a current collector to form the battery electrode.

In an embodiment, the electrode material can be formed by using any suitable methodology. In some embodiments, forming the electrode material can be a dry or solvent-free process such as fibrillating binder technology as referred in U.S. Pat. No. 6,127,474, which is incorporated by reference herein in its entirety. In other embodiments, forming the electrode material can involve a minimal amount of solvent, such as in ultra-violet or electron beam curable processes. In certain instances, solvent-free processes can employ a minimal amount of solvent in one or more of the steps required for forming the electrode material. As will be appreciated by one of skill in the art, and with the help of this disclosure, solvent-free processes are actually “mostly solvent-free” in certain instances.

In some embodiments, the electrode material can be formed in water, an aqueous solvent, an organic solvent, an emulsion, and the like, or combinations thereof.

In an embodiment, the method of making a battery electrode can further comprise configuring a first battery electrode as an anode; configuring a second battery electrode as a cathode; and placing the anode, the cathode and an electrolyte in a housing, wherein the electrolyte is disposed between the anode and the cathode. Generally, the electrolyte provides for transporting positive lithium ions between the cathode and the anode.

In an embodiment, the electrolyte (e.g., electrolyte for a lithium ion battery) can be a liquid-based lithium ion electrolyte, a gel-based lithium ion electrolyte, or a solid-state lithium ion electrolyte.

In an embodiment, liquid-based lithium ion electrolytes in lithium ion batteries (LIBs) can comprise a lithium salt, such as LiPF₆, LiBF₄, LiClO₄, and the like, or combinations thereof, in an organic solvent, such as an organic carbonate, for example ethylene carbonate, dimethyl carbonate, diethyl carbonate, propylene carbonate, ethylmethyl carbonate, and the like, or combinations thereof.

In an embodiment, gel-based lithium ion electrolytes and/or solid-state lithium ion electrolytes in lithium ion batteries (LIBs) can comprise polymers such as poly(ethylene oxide) (PEO), polyacrylonitrile (PAN), polyvinylidene fluoride (PVDF), poly(methyl-methacrylate) (PMMA), and the like, copolymers thereof, or combinations thereof. Generally, the use of a polymer electrolyte (e.g., gel-based lithium ion electrolytes and/or solid-state lithium ion electrolytes) can overcome certain cell configuration constraints, and can make thin film lithium ion polymer batteries possible. In the case of a solid electrolyte, the lithium salt can be contained in a polymer membrane, such as PEO containing LiPF₆. Both solid electrolytes and gel electrolytes are using polymer membranes as a host matrix, but the difference between a solid electrolyte and a gel electrolyte is the solvent content: the gel electrolyte contains more solvent than the solid electrolyte.

In an embodiment, a battery (e.g., LIB) can comprise a housing, the housing having disposed therein (1) a battery electrode as disclosed herein configured as an anode, (2) a battery electrode as disclosed herein configured as a cathode, and (3) an electrolyte disposed between the anode and the cathode.

LIBs provide lightweight, high energy density power sources for a variety of devices. LIBs can be used in portable devices, mobile phones, smartphones, laptops, tablets, digital cameras, camcorders, electronic cigarettes, handheld game consoles, electronic torches (flashlights); power tools, cordless drills, cordless sanders, cordless saws, cordless hedge trimmers; electric vehicles, electric cars, hybrid vehicles, advanced electric wheelchairs, radio-controlled models, model aircrafts; telecommunications, backup power sources; etc.

In an embodiment, a battery electrode can be configured as an anode, wherein the current collector comprises Cu, wherein the polymeric binder comprises one or more sulfonyl groups, wherein the lithium-based electrochemically active material comprises Li₁₅Si₄, and wherein the electrically conductive filler comprises carbon.

In an embodiment, a battery electrode can be configured as a cathode, wherein the current collector comprises Al, wherein the polymeric binder comprises one or more sulfonyl groups, wherein the lithium-based electrochemically active material comprises LCO and NMC, and wherein the electrically conductive filler comprises carbon.

In an embodiment, a battery (e.g., LIB) can comprise a housing, the housing having disposed therein (1) a battery electrode as disclosed herein configured as an anode, wherein the current collector comprises Cu, wherein the polymeric binder comprises one or more sulfonyl groups, wherein the lithium-based electrochemically active material comprises Li₁₅Si₄, and wherein the electrically conductive filler comprises carbon; (2) a battery electrode as disclosed herein configured as a cathode, wherein the current collector comprises Al, wherein the polymeric binder comprises one or more sulfonyl groups, wherein the lithium-based electrochemically active material comprises LCO and NMC, and wherein the electrically conductive filler comprises carbon; and (3) an electrolyte disposed between the anode and the cathode, wherein the electrolyte comprises LiPF₆ and an organic carbonate.

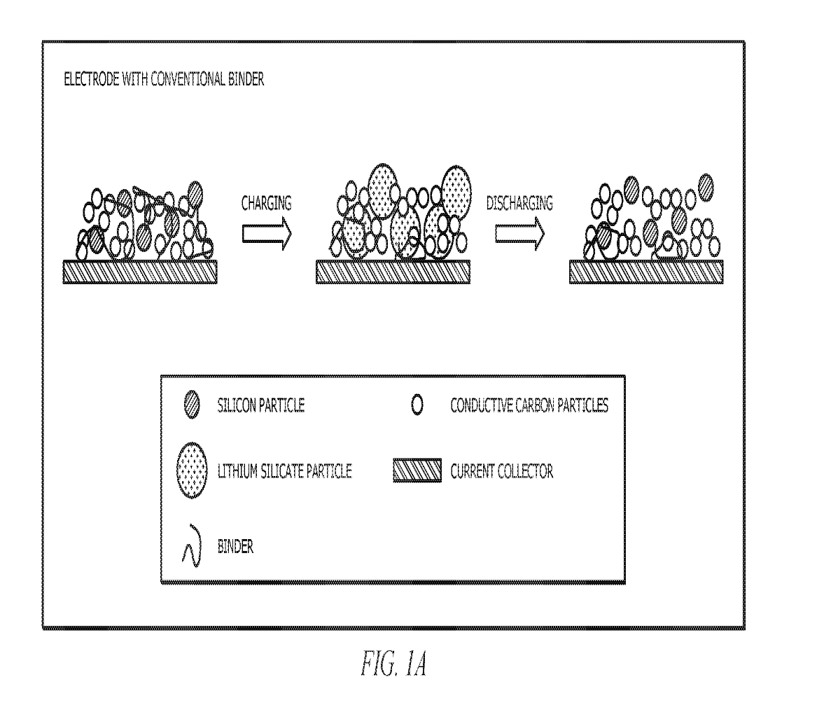

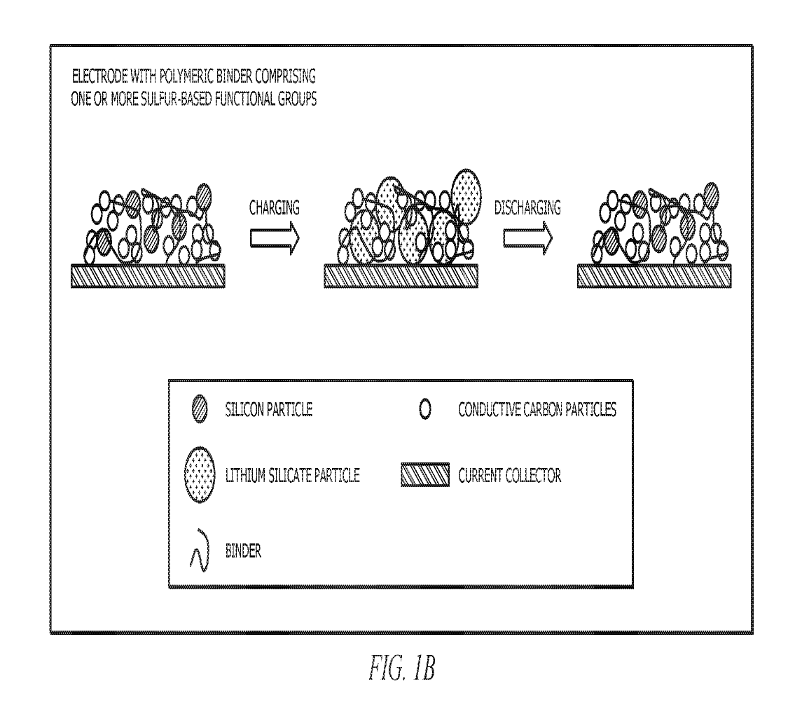

In an embodiment, the electrode material compositions comprising a polymeric binder having one or more sulfur-based functional groups, and methods of making and using same, as disclosed herein can advantageously display improvements in one or more composition characteristics when compared to an otherwise similar electrode material composition lacking a polymeric binder having one or more sulfur-based functional groups. FIG. 1A displays a schematic of a conventional silicon anode during charging and discharging of a LIB, and FIG. 1B displays a schematic of a silicon anode comprising a polymeric binder as disclosed herein during charging and discharging of a LIB. Conventional binders (FIG. 1A) do not provide the necessary binding with silicon, lithium silicates, conductive carbon and current collector, and thus the particles are not kept in electrical contact with each other during charging and discharging. The use of sulfur-based functional groups in the polymeric binder (FIG. 1B) advantageously allows the necessary binding required to keep electrode material particles in electrical contact with each other during charging and discharging. Additional advantages of the polymeric binder having one or more sulfur-based functional groups, and methods of using same, as disclosed herein can be apparent to one of skill in the art viewing this disclosure.

### EXAMPLES

The subject matter having been generally described, the following examples are given as particular embodiments of the disclosure and to demonstrate the practice and advantages thereof. It is understood that the examples are given by way of illustration and are not intended to limit the specification of the claims to follow in any manner.

### Example 1

In order to identify the functional groups that would provide higher binding strength (e.g., higher binding energy), ab initio simulations were performed in a density functional theory (DFT) framework. Ab initio quantum mechanical calculations were carried out on various functional groups (as outlined in Table 1) attached to vinyl polymers characterized by general formula —(CH₂— CH_{R})ₙ—.

TABLE 1

| Functional group | Formula |
|---|---|
| Hydroxyl | ROH |
| Aldehyde | RCHO |
| Amide | RCONR₂ |
| Amine | RNH₂ |
| Diimide | RN₂R′ |
| Ester | RCOOR′ |
| Carboxyl | RCOOH |
| Cyanate | RCOCN |
| Ether | ROR′ |
| Imine | RCNH₂ |
| Ketone | RCOR′ |
| Nitrate | RONO₂ |
| Nitrile | RCN |
| Nitrite | RONO |
| Imide | (RCO)₂NR′ |
| Sulfonyl | RSO₂R′ |
| Sulfo | RSO₃H |
| Thiol | RSH |
| S-Nitrosothiol | RSNO |
| Sulfide | RSR′ |
| Disulfide | RSSR′ |
| Sulfenic acid | RSOH |
| Sulfinic acid | RSO₂H |
| Sulfonate ester | RSO₃R′ |
| Sulfoxide | R—S(═O)—R′ |

Binding energy (BE) interactions between functional groups and anode materials (silicon, carbon, lithium silicates) were investigated by constructing suitable molecular models of vinyl polymeric units having the functional groups in an interacting orientation with active electrode materials.

Method:

Computational chemistry calculations were performed using Gaussian-09 quantum chemistry package, Jaguar module as incorporated in Schrodinger software suite and using the Vienna Ab Initio Simulation Package (VASP) as incorporated in Materials Design (MedeA) software suite. The DFT method underlying VASP for studying periodic systems uses GGA-PW, which is based on a plane-wave basis set. The DFT calculations for non-periodic systems were carried out at the M06-2X//6-31++G(d,p) level of theory, which uses a M06-2X high-non-locality functional with double the amount of nonlocal exchange (2X). The geometries of all molecular structures were fully optimized using the M06-2X method, using the 6-31++G(d,p) basis set (a split-valence Gaussian basis set augmented with diffuse functions), denoted as M06-2X/6-31++G(d,p)//M06-2X/6-31++G(d,p). Frequency calculations were used to characterize the stationary points as minima and to obtain zero-point vibrational energies (ZPEs). For the discussion herein, the calculated binding energies are referred to in here as the “DFT results.”

Generally, a functional group refers to a portion of a molecule that is a recognizable/classified group of bound atoms. Use of functional group(s) is a common practice in developing binders for many applications. Selection of functional groups can be key to achieve a better binding among different constituents of an electrode. Binding energy interaction is considered a key parameter for having higher interaction between binder and other constituents of an electrode. The binding energy can give information regarding the stabilization upon the interaction of the functional group with the electrochemically active material. The binding energy, as referred herein, corresponds to the difference in energy between the initial state (polymer model with functional group interacting with the electrochemically active material) and the final state (polymer model with the functional group, plus the non-interacting electrochemically active material). Without wishing to be limited by theory, the binding energy is the energy required to disassemble a whole system into its separate component parts. By this definition, the binding energy corresponds to a positive binding energy.

Silicon used as anode in lithium ion batteries (LIBs) can react with lithium during charging to form different lithium-silicon compounds such as Li₁₅Si₄, Li₂₂Si₅, Li₁₂Si₇, Li₂Si₁, Li₇Si₂, and Li₁Si₁. Li₁₅Si₄ is regarded as a fully lithiated state. The computational procedure followed for producing the results described herein is based on three different system optimizations, i.e., for the isolated LiₓSi_{y} system, for the isolated polymeric unit containing the functional group, and for the total system including the functional group interacting with LiₓSi_{y}. LiₓSi_{y} systems were simulated using a Li₄Si₁ cluster for the molecular calculations, and the (100) surface of Li₁₅Si₄, Li₂₂Si₅, Li₁₂Si₇, Li₂Si₁, and Li₁Si₁ for the periodic calculations. In both cases, the binder was simulated by a single vinyl unit containing the functional group. The active material of anode was based on pure copper (current collector) or silicon lithiates with different Li/Si ratios.

The results from the calculations (Gaussian-09 and Jaguar software) on the molecular structures are reported in Table 2, which displays binding energy (BE) interaction values between functional groups and Li₄Si.

TABLE 2

| Functional group | BE [eV] |
|---|---|
| Sulfoxide | 1.57 |
| Carboxyl | 1.52 |
| Sulfinic acid | 1.44 |
| Sulfonyl | 1.38 |
| Amide | 1.37 |
| Imine | 1.31 |
| Sulfonate ester | 1.30 |
| Imide | 1.29 |
| Sulfo | 1.28 |
| Aldehyde | 1.24 |
| Amine | 1.23 |
| Sulfenic acid | 1.21 |
| Ester | 1.19 |
| Ketone | 1.16 |
| Ether | 1.14 |
| Hydroxyl | 1.13 |
| Cyanate | 1.12 |
| Nitrate | 1.01 |
| Sulfide | 0.98 |
| Nitrile | 0.97 |
| Diimide | 0.97 |
| Thiol | 0.93 |
| Nitrite | 0.88 |
| Disulfide | 0.88 |
| S-Nitrosothiol | 0.79 |

The DFT results indicate that functional groups like sulfoxide, carboxyl, sulfinic acid, sulfonyl, amide, and imine, have significant binding interactions with Li₄Si, which is a surrogate of the Li₁₅Si₄ cluster system. Sulfoxide functional group provides the strongest interaction, with a binding energy value of 1.57 eV. As it can be seen in Table 2, the interactions between sulfoxide, sulfinic acid, sulfonyl, sulfonate ester and sulfo with Li₄Si is comparable to carboxyl, imide, imine and amide, suggesting that the presence of sulfur containing functional groups is desirable for stronger binding of silicon particles. The results displayed in Table 2 indicate that the presence of sulfur containing functional groups (e.g., sulfur-based functional groups) in a binder can provide stronger binding during charging to the full lithiated state. Such stronger binding would allow silicon particles to remain in electrical contact during volume expansion associated with lithiation of silicon.

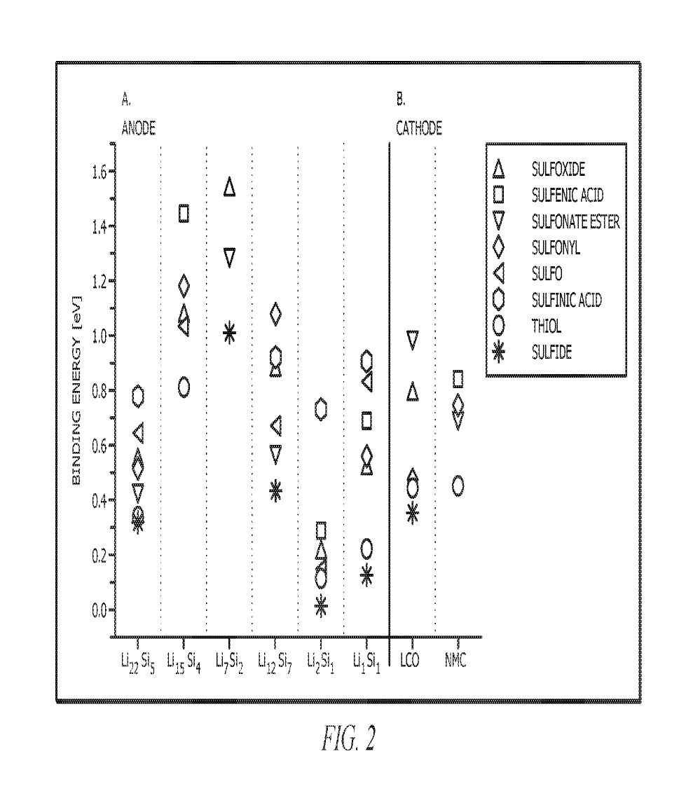

The binding interaction between the sulfur-based functional groups (e.g., sulfoxide, sulfenic acid, sulfonate ester, sulfonyl, sulfo, sulfide and thiol) and the other silicon lithiates systems is shown in FIG. 2A, which displays the binding energy in eV of the selected functional groups with different lithium-silicon compounds.

The results in FIG. 2A show that in general, the interaction with LiₓSi_{y} systems is weaker than the interaction with the Li₁₅Si₄ system, except for the Li₇Si₂ system.

### Example 2

Binding energies between the electrochemically active material of cathode and selected sulfur-based functional groups were also determined. The electrochemically active material in the case of the cathode was based on lithium cobalt oxide (LCO) and lithium nickel manganese cobalt oxide (NMC). The computational procedure was as described in Example 1, and it was based on three different system optimizations, i.e., for the isolated cathode active material, for the isolated polymeric unit containing the functional group, and for the total system including the functional group interacting with the cathode active material. The binder was simulated by a single vinyl unit containing the functional group. The results related to the interaction of the sulfur-based functional groups with LCO and NMC are reported in FIG. 2B, which displays binding energy values (binding energy [eV]) of the selected functional groups with LCO and NMC.

As it can be seen from FIG. 2B, sulfonate ester, sulfoxide, sulfonyl and sulfenic acid groups show significant interaction with LCO and NMC.

Molecular structure optimization and energy minimization using first principles calculations show that sulfur containing functional groups, including but not limited to, sulfonyl, sulfo, sulfoxides, sulfonate esters, sulfones, sulfinic acid, sulfenic acid, sulfides, disulfides, thiols and nitrosothiols have favorable binding energies for use in binders for silicon based anodes, and for LCO and NMC based cathodes. The sulfur containing functional group(s) can be inherent part of the polymer or can be attached to the base polymer via chemical functionalization. The amount and type of sulfur containing groups can be varied based on the binding energy value. Also, the functional groups amount and type can be adjusted based on particle size of active material and ease of manufacturability of functional groups. Smaller particles of active material would have higher specific surface area and thus would need more functional groups than others. A particulate polymer used as a polymeric binder can be soluble in water or organic solvent, or can be emulsion based, or can be processed via a solvent-free or dry electrode manufacturing process.

For the purpose of any U.S. national stage filing from this application, all publications and patents mentioned in this disclosure are incorporated herein by reference in their entireties, for the purpose of describing and disclosing the constructs and methodologies described in those publications, which might be used in connection with the methods of this disclosure. Any publications and patents discussed herein are provided solely for their disclosure prior to the filing date of the present application. Nothing herein is to be construed as an admission that the inventors are not entitled to antedate such disclosure by virtue of prior invention.

In any application before the United States Patent and Trademark Office, the Abstract of this application is provided for the purpose of satisfying the requirements of 37 C.F.R. § 1.72 and the purpose stated in 37 C.F.R. § 1.72(b) “to enable the United States Patent and Trademark Office and the public generally to determine quickly from a cursory inspection the nature and gist of the technical disclosure.” Therefore, the Abstract of this application is not intended to be used to construe the scope of the claims or to limit the scope of the subject matter that is disclosed herein. Moreover, any headings that can be employed herein are also not intended to be used to construe the scope of the claims or to limit the scope of the subject matter that is disclosed herein. Any use of the past tense to describe an example otherwise indicated as constructive or prophetic is not intended to reflect that the constructive or prophetic example has actually been carried out.

The present disclosure is further illustrated by the following examples, which are not to be construed in any way as imposing limitations upon the scope thereof. On the contrary, it is to be clearly understood that resort can be had to various other aspects, embodiments, modifications, and equivalents thereof which, after reading the description herein, can be suggest to one of ordinary skill in the art without departing from the spirit of the present invention or the scope of the appended claims.

### Additional Disclosure

A first embodiment, which is an electrode material comprising (a) a polymeric binder, (b) a lithium-based electrochemically active material, and (c) an electrically conductive filler; wherein the polymeric binder comprises one or more sulfur-based functional groups; and wherein the electrode material is characterized by a binding energy between the one or more sulfur-based functional groups and the lithium-based electrochemically active material of from about 0.3 eV to about 2.5 eV.

A second embodiment, which is the electrode material of the first embodiment, wherein one or more of the sulfur-based functional groups comprises a sulfonyl group, a sulfo group, a thiol group, a S-nitrosothiol group, a sulfide group, a disulfide group, a sulfenic acid group, a sulfinic acid group, a sulfonate ester group, a sulfoxide group, a thiocyanate group, an isothiocyanate group, or combinations thereof.

A third embodiment, which is the electrode material of the second embodiment, wherein the sulfonyl group comprises sulfonyl halide, sulfonyl chloride, sulfonyl bromide, sulfonyl fluoride, p-toluenesulfonyl, p-bromobenzenesulfonyl, 2-nitrobenzenesulfonyl, 4-nitrobenzenesulfonyl, methanesulfonyl, trifluoromethanesulfonyl, 5-(dimethylamino)naphthalene-1-sulfonyl, or combinations thereof.

A fourth embodiment, which is the electrode material of any one of the first through the third embodiments, wherein the sulfide group comprises an alkyl sulfide, a methyl sulfide, ethyl sulfide, propyl sulfide, butyl sulfide, an aryl sulfide, an arylalkyl sulfide, or combinations thereof.

A fifth embodiment, which is the electrode material of any one of the first through the fourth embodiments, wherein the sulfonate ester comprises an alkyl sulfonate ester, a methyl sulfonate ester, an ethyl sulfonate ester, a propyl sulfonate ester, a butyl sulfonate ester, an aryl sulfonate ester, an arylalkyl sulfonate ester, or combinations thereof.

A sixth embodiment, which is the electrode material of any one of the first through the fifth embodiments, wherein the sulfoxide group comprises an alkyl sulfoxide, methyl sulfoxide, ethyl sulfoxide, propyl sulfoxide, butyl sulfoxide, an aryl sulfoxide, an arylalkyl sulfoxide, or combinations thereof.

A seventh embodiment, which is the electrode material of any one of the first through the sixth embodiments, wherein the polymeric binder comprises a polymer backbone selected from the group consisting of polyvinyl, polyvinyl ester, polyvinyl ether, polyvinyl ketone, polyvinyl halide, polyester, polyolefin, polyethylene, polypropylene, polyarylene sulfide, polyphenylene sulfide, polysulfone, polyethersulfone, polythioester, polythioether, polyphenylene oxide, polystyrene, styrene-butadiene rubber, polyacrylate, polyacrylonitrile, polymethacrylate, polyetherimide, polyamide, polyacrylamide, phenolic polymer, fluoropolymer, furan polymer, polycarbamate, polyurethane, polycarbonate; conductive polymers; polyacetylene, polydiacetylene, polypyrrole, polythiophene; polyphenylene, poly(paraphenylene), poly(p-phenylene vinylene), poly(phenyleneethynylene), polyaniline; polyene, polaron, bipolaron, soliton; polyfluorene; analogues thereof; copolymers thereof; and combinations thereof.

An eighth embodiment, which is the electrode material of the seventh embodiment, wherein the polymeric binder is obtained by polymerizing at least one monomer comprising the one or more sulfur-based functional groups into the polymer backbone.

A ninth embodiment, which is the electrode material of the seventh embodiment, wherein the polymeric binder is obtained by chemically functionalizing the polymer backbone with the one or more sulfur-based functional groups.

A tenth embodiment, which is the electrode material of any one of the first through the ninth embodiments, wherein the polymeric binder is present in the electrode material in an amount that is reduced by equal to or greater than about 25 wt. %, based on the total weight of the electrode material, when compared to an otherwise similar electrode material comprising a polymeric binder lacking one or more sulfur-based functional groups.

An eleventh embodiment, which is the electrode material of any one of the first through the tenth embodiments, wherein the lithium-based electrochemically active material is present in the electrode material in an amount that is increased by equal to or greater than about 25 wt. %, based on the total weight of the electrode material, when compared to an otherwise similar electrode material comprising a polymeric binder lacking one or more sulfur-based functional groups.

A twelfth embodiment, which is a battery electrode comprising (i) a current collector and (ii) the electrode material of the first embodiment.

A thirteenth embodiment, which is a battery comprising a housing, the housing having disposed therein: (1) a battery electrode according to the twelfth embodiment configured as an anode, (2) a battery electrode according to the twelfth embodiment configured as a cathode, and (3) an electrolyte disposed between the anode and the cathode.

A fourteenth embodiment, which is the battery electrode of the twelfth embodiment configured as an anode, wherein the lithium-based electrochemically active material comprises a lithium-silicon compound characterized by formula LiₓSi_{y}, wherein x is an integer from 1 to about 25, wherein y is an integer from 1 to about 10, and wherein x is equal to or greater than y.

A fifteenth embodiment, which is the battery electrode of the fourteenth embodiment, wherein the lithium-silicon compound comprises Li₁₅Si₄, Li₂₂Si₅, Li₁₂Si₇, Li₂Si₁, Li₁Si₁, Li₁₃Si₄, Li₇Si₃, Li₇Si₂, or combinations thereof.

A sixteenth embodiment, which is the battery electrode of any one of the fourteenth and the fifteenth embodiments, wherein the anode is characterized by a drop in specific capacity over a battery cycle life that is decreased by equal to or greater than about 30%, when compared to an otherwise similar anode comprising a polymeric binder lacking one or more sulfur-based functional groups.

A seventeenth embodiment, which is the battery electrode of any one of the fourteenth through the sixteenth embodiments, wherein the anode is characterized by a drop in specific capacity over a battery cycle life of less than about 30%.

An eighteenth embodiment, which is the battery electrode of the twelfth embodiment configured as a cathode, wherein the lithium-based electrochemically active material comprises a lithium-transition metal oxide, FeF₃, FeF₂, CoF₂, NiF₂, FeS₂, V₂O₅, or combinations thereof.

A nineteenth embodiment, which is the battery electrode of the eighteenth embodiment, wherein the lithium-transition metal oxide comprises lithium cobalt oxide (LiCoO₂, LCO), lithium manganese oxide (LiMn₂O₄, LMO), lithium nickel manganese cobalt oxide (LiNiMnCoO₂, NMC), lithium nickel cobalt aluminum oxide (LiNiCoAlO₂), lithium titanate (Li₄Ti₅O₁₂), lithium iron borate (LiFeBO₃), lithium vanadium fluorophosphate (LiVPO₄F), lithium manganese phosphate (LiMnPO₄), lithium manganese silicate (Li₂MnSiO₄), or combinations thereof.

A twentieth embodiment, which is the battery electrode of any one of the eighteenth and the nineteenth embodiments, wherein the cathode is characterized by an energy density that is increased by equal to or greater than about 5%, when compared to an otherwise similar cathode comprising a polymeric binder lacking one or more sulfur-based functional groups.

A twenty-first embodiment, which is the battery of the thirteenth embodiment, wherein the electrolyte is a liquid-based lithium ion electrolyte, a gel-based lithium ion electrolyte, or a solid-state lithium ion electrolyte.

A twenty-second embodiment, which is which is the electrode material of any one of the first through the eleventh embodiments, wherein the sulfo group comprises an alkyl sulfo group, a methyl sulfo group, an ethyl sulfo group, a propyl sulfo group, a butyl sulfo group, an aryl sulfo group, an arylalkyl sulfo group, or combinations thereof.

A twenty-third embodiment, which is which is the electrode material of any one of the first through the eleventh embodiments, wherein the sulfenic acid group comprises an alkyl sulfenic acid group, a methyl sulfenic acid group, an ethyl sulfenic acid group, a propyl sulfenic acid group, a butyl sulfenic acid group, an aryl sulfenic acid group, an arylalkyl sulfenic acid group, or combinations thereof.

A twenty-fourth embodiment, which is which is the electrode material of any one of the first through the eleventh embodiments, wherein the sulfinic acid group comprises an alkyl sulfinic acid group, a methyl sulfinic acid group, an ethyl sulfinic acid group, a propyl sulfinic acid group, a butyl sulfinic acid group, an aryl sulfinic acid group, an arylalkyl sulfinic acid group, or combinations thereof.

A twenty-fifth embodiment, which is a method of making a battery electrode comprising (i) mixing a lithium-based electrochemically active material, an electrically conductive filler, and a polymeric binder to form an electrode material, wherein the polymeric binder comprises one or more sulfur-based functional groups; and (ii) contacting the electrode material with a current collector to form the battery electrode.

A twenty-sixth embodiment, which is the method of the twenty-fifth embodiment, wherein forming the electrode material is a dry process.

A twenty-seventh embodiment, which is the method of the twenty-fifth embodiment, wherein the electrode material is formed in water, an aqueous solvent, an organic solvent, an emulsion, or combinations thereof.

A twenty-eighth embodiment, which is the method of any one of the twenty-fifth through the twenty-seventh embodiments further comprising configuring a first battery electrode as an anode; configuring a second battery electrode as a cathode; and placing the anode, the cathode and an electrolyte in a housing, wherein the electrolyte is disposed between the anode and the cathode.

While embodiments of the disclosure have been shown and described, modifications thereof can be made without departing from the spirit and teachings of the invention. The embodiments and examples described herein are exemplary only, and are not intended to be limiting. Many variations and modifications of the invention disclosed herein are possible and are within the scope of the invention.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the detailed description of the present invention. The disclosures of all patents, patent applications, and publications cited herein are hereby incorporated by reference.

1. An electrode material comprising (a) a polymeric binder, (b) a lithium-based electrochemically active material, and (c) an electrically conductive filler; wherein the polymeric binder comprises one or more sulfur-based functional groups; and wherein the electrode material is characterized by a binding energy between the one or more sulfur-based functional groups and the lithium-based electrochemically active material of from about 0.3 eV to about 2.5 eV.

2. The electrode material of claim 1, wherein one or more of the sulfur-based functional groups comprises a sulfonyl group, a sulfo group, a thiol group, a S-nitrosothiol group, a sulfide group, a disulfide group, a sulfenic acid group, a sulfinic acid group, a sulfonate ester group, a sulfoxide group, a thiocyanate group, an isothiocyanate group, or combinations thereof.

3. The electrode material of claim 2, wherein the sulfonyl group comprises sulfonyl halide, sulfonyl chloride, sulfonyl bromide, sulfonyl fluoride, p-toluenesulfonyl, p-bromobenzenesulfonyl, 2-nitrobenzenesulfonyl, 4-nitrobenzenesulfonyl, methanesulfonyl, trifluoromethanesulfonyl, 5-(dimethylamino)naphthalene-1-sulfonyl, or combinations thereof;
wherein the sulfide group comprises an alkyl sulfide, a methyl sulfide, ethyl sulfide, propyl sulfide, butyl sulfide, an aryl sulfide, an arylalkyl sulfide, or combinations thereof;
wherein the sulfonate ester comprises an alkyl sulfonate ester, a methyl sulfonate ester, an ethyl sulfonate ester, a propyl sulfonate ester, a butyl sulfonate ester, an aryl sulfonate ester, an arylalkyl sulfonate ester, or combinations thereof;
wherein the sulfoxide group comprises an alkyl sulfoxide, methyl sulfoxide, ethyl sulfoxide, propyl sulfoxide, butyl sulfoxide, an aryl sulfoxide, an arylalkyl sulfoxide, or combinations thereof; wherein the sulfo group comprises an alkyl sulfo group, a methyl sulfo group, an ethyl sulfo group, a propyl sulfo group, a butyl sulfo group, an aryl sulfo group, an arylalkyl sulfo group, or combinations thereof;
wherein the sulfenic acid group comprises an alkyl sulfenic acid group, a methyl sulfenic acid group, an ethyl sulfenic acid group, a propyl sulfenic acid group, a butyl sulfenic acid group, an aryl sulfenic acid group, an arylalkyl sulfenic acid group, or combinations thereof;
wherein the sulfinic acid group comprises an alkyl sulfinic acid group, a methyl sulfinic acid group, an ethyl sulfinic acid group, a propyl sulfinic acid group, a butyl sulfinic acid group, an aryl sulfinic acid group, an arylalkyl sulfinic acid group, or combinations thereof; and
wherein the polymeric binder comprises a polymer backbone selected from the group consisting of polyvinyl, polyvinyl ester, polyvinyl ether, polyvinyl ketone, polyvinyl halide, polyester, polyolefin, polyethylene, polypropylene, polyarylene sulfide, polyphenylene sulfide, polysulfone, polyethersulfone, polythioester, polythioether, polyphenylene oxide, polystyrene, styrene-butadiene rubber, polyacrylate, polyacrylonitrile, polymethacrylate, polyetherimide, polyamide, polyacrylamide, phenolic polymer, fluoropolymer, furan polymer, polycarbamate, polyurethane, polycarbonate; conductive polymers; polyacetylene, polydiacetylene, polypyrrole, polythiophene; polyphenylene, poly(paraphenylene), poly(p-phenylene vinylene), poly(phenyleneethynylene), polyaniline; polyene, polaron, bipolaron, soliton; polyfluorene; analogues thereof; copolymers thereof; and combinations thereof.

4. The electrode material of claim 3, wherein the polymeric binder is obtained by polymerizing at least one monomer comprising the one or more sulfur-based functional groups into the polymer backbone or wherein the polymeric binder is obtained by chemically functionalizing the polymer backbone with the one or more sulfur-based functional groups.

5. The electrode material of claim 1, wherein the polymeric binder is present in the electrode material in an amount that is reduced by equal to or greater than about 25 wt. %, based on the total weight of the electrode material, when compared to an otherwise similar electrode material comprising a polymeric binder lacking one or more sulfur-based functional groups.

6. The electrode material of claim 1, wherein the lithium-based electrochemically active material is present in the electrode material in an amount that is increased by equal to or greater than about 25 wt. %, based on the total weight of the electrode material, when compared to an otherwise similar electrode material comprising a polymeric binder lacking one or more sulfur-based functional groups.

7. A battery electrode comprising (i) a current collector and (ii) the electrode material of claim 1.

8. A battery comprising a housing, the housing having disposed therein: (1) a battery electrode according to claim 7 configured as an anode, (2) a battery electrode according to claim 7 configured as a cathode, and (3) an electrolyte disposed between the anode and the cathode.

9. The battery electrode of claim 7 configured as an anode, wherein the lithium-based electrochemically active material comprises a lithium-silicon compound characterized by formula LiₓSi_{y}, wherein x is an integer from 1 to about 25, wherein y is an integer from 1 to about 10, and wherein x is equal to or greater than y.

10. The battery electrode of claim 9, wherein the lithium-silicon compound comprises Li₁₅Si₄, Li₂₂Si₅, Li₁₂Si₇, Li₂Si₁, Li₁Si₁, Li₁₃Si₁₄, Li₇Si₃, Li₇Si₂, or combinations thereof.

11. The battery electrode of claim 9, wherein the anode is characterized by a drop in specific capacity over a battery cycle life that is decreased by equal to or greater than about 30%, when compared to an otherwise similar anode comprising a polymeric binder lacking one or more sulfur-based functional groups.

12. The battery electrode of claim 9, wherein the anode is characterized by a drop in specific capacity over a battery cycle life of less than about 30%.

13. The battery electrode of claim 7 configured as a cathode, wherein the lithium-based electrochemically active material comprises a lithium-transition metal oxide, FeF₃, FeF₂, CoF₂, NiF₂, FeS₂, V₂O₅, or combinations thereof.

14. The battery electrode of claim 13, wherein the lithium-transition metal oxide comprises lithium cobalt oxide (LiCoO₂, LCO), lithium manganese oxide (LiMn₂O₄, LMO), lithium nickel manganese cobalt oxide (LiNiMnCoO₂, NMC), lithium nickel cobalt aluminum oxide (LiNiCoAlO₂), lithium titanate (Li₄Ti₅O₁₂), lithium iron borate (LiFeBO₃), lithium vanadium fluorophosphate (LiVPO₄F), lithium manganese phosphate (LiMnPO₄), lithium manganese silicate (Li₂MnSiO₄), or combinations thereof.

15. The battery electrode of claim 13, wherein the cathode is characterized by an energy density that is increased by equal to or greater than about 5%, when compared to an otherwise similar cathode comprising a polymeric binder lacking one or more sulfur-based functional groups.

16. The battery of claim 8, wherein the electrolyte is a liquid-based lithium ion electrolyte, a gel-based lithium ion electrolyte, or a solid-state lithium ion electrolyte.

17. A method of making a battery electrode comprising:
(i) mixing a lithium-based electrochemically active material, an electrically conductive filler, and a polymeric binder to form an electrode material, wherein the polymeric binder comprises one or more sulfur-based functional groups; and
(ii) contacting the electrode material with a current collector to form the battery electrode.

18. The method of claim 17, wherein forming the electrode material is a dry process.

19. The method of claim 17, wherein the electrode material is formed in water, an aqueous solvent, an organic solvent, an emulsion, or combinations thereof.

20. The method of claim 17, further comprising configuring a first battery electrode as an anode; configuring a second battery electrode as a cathode; and placing the anode, the cathode and an electrolyte in a housing, wherein the electrolyte is disposed between the anode and the cathode.
